(19) United States
(12) Patent Application Publication
(10) Pub. No.: US 2014/0351083 A1
(43) Pub. Date: Nov. 27, 2014

(54) Systems and Methods for Providing a Software License

(71) Applicant: The Procter & Gamble Company, Cincinnati, OH (US)

(72) Inventors: Adam Matthew Lux, Milford, OH (US); Paul Edward Schauer, Maineville, OH (US); Timothy Robert Dennedy, Loveland, OH (US)

(73) Assignee: The Procter & Gamble Company, Cincinnati, OH (US)

(21) Appl. No.: 14/268,289

(22) Filed: May 2, 2014

Related U.S. Application Data
(60) Provisional application No. 61/826,039, filed on May 22, 2013.

(51) Int. Cl. G06Q 50/18; G06Q 30/06

(52) U.S. Cl. CPC G06Q 50/184; G06Q 30/0633
USPC 705/26.8; 705/310

(57) ABSTRACT

Included are embodiments for providing a software license. Some embodiments include providing a closed network marketplace that includes a plurality of pieces of licensed software, receiving an indication from a user computing device to acquire a desired licensed software from the closed network marketplace, sending the desired licensed software to the user computing device, and receiving data from an agent application, the agent application causing the user computing device to monitor use of the desired licensed software on the user computing device. In some embodiments, in response to receiving the data from the agent application, providing, by a computing device, a user option may be provided to remove the desired licensed software from the user computing device, thereby effectively returning the software license associated with the desired licensed software such that the software license may be used on another computing device.

### FIELD OF THE INVENTION

The present application relates generally to systems and methods for providing a software license and specifically to providing a platform for maintaining software license compliance, while providing software to a plurality of users.

### BACKGROUND OF THE INVENTION

In many corporate environments, employees may have individual workstation computers that are utilized for differing tasks, depending on the employee. Based on his/her tasks, the employee may utilize a company expense account to purchase specific software packages to perform those desired tasks. One issue with such a situation is that the company may be unknowingly violating software licenses because employees may not recognize or understand the extent of the license that is associated with purchased software package. A second issue is that the employee may wastefully spend company money because the software package is purchased for a single project and will not be used again.

### SUMMARY OF THE INVENTION

Included are embodiments of a method for providing a software license. Some embodiments include providing a closed network marketplace that includes a plurality of pieces of licensed software, receiving an indication from a user computing device to acquire a desired licensed software from the closed network marketplace, sending the desired licensed software to the user computing device, and receiving data from an agent application, the agent application causing the user computing device to monitor use of the desired licensed software on the user computing device. In some embodiments, in response to receiving the data from the agent application, a user option may be provided to remove the desired licensed software from the user computing device, thereby effectively returning the software license associated with the desired licensed software such that the software license may be used on another computing device.

Also included are embodiments of a system. Some embodiments of the system include a memory component that stores logic, that when executed by the system, causes the system to provide a marketplace for members of a corporate entity to acquire a desired licensed software, the marketplace providing a plurality of pieces of licensed software, receive an indication from a user computing device to acquire the desired licensed software from the marketplace, wherein the user computing device stores an agent application for monitoring use of the user computing device, and send the desired licensed software to the user computing device. In some embodiments, the logic causes the system to receive data from the agent application, the data indicating that the desired licensed software has not been used on the user computing device for predetermined amount of time and receive an indication from the user computing device to remove the desired licensed software from the user computing, effectively returning the software license associated with the desired licensed software, the indication being received in response to a selection of a user option.

Also included are embodiments of a non-transitory computer-readable medium. Some embodiments of the non-transitory computer-readable medium include a computer program that causes a computing device to provide a marketplace for members of a corporate entity to acquire a desired licensed software, receive an indication from a user computing device of the corporate entity to acquire the desired licensed software from the marketplace, where the user computing device stores an agent application for monitoring use of the user computing device, and send the desired licensed software to the user computing device. In some embodiments, the computer program causes the computing device to receive data from the agent application, the data indicating that the desired licensed software has not been used on the user computing device for predetermined amount of time and receive an indication from the user computing device to disable use of the desired licensed software by the user computing device, thereby effectively returning the software license associated with the desired licensed software for use with another computing device, the indication being received in response to a selection of a user option.

### BRIEF DESCRIPTION OF THE DRAWINGS

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

FIG. 1 depicts a computing environment for providing a software license, according to embodiments disclosed herein;

FIG. 2 depicts components of a remote computing device for providing a software license, according to embodiments disclosed herein;

FIG. 3 depicts a user interface for providing options related to licensed software that a user may utilize, according to embodiments disclosed herein;

FIG. 4 depicts a user interface for providing a marketplace to purchase and/or rent software, according to embodiments disclosed herein;

FIG. 5 depicts a user interface for locating software from an external vendor site to the marketplace, according to embodiments disclosed herein;

FIG. 6 depicts a user interface for purchasing and/or renting software through an external vendor site, via the marketplace, according to embodiments disclosed herein;

FIG. 7 depicts a user interface for providing a listing of software that a user has acquired on a user computing device, according to embodiments disclosed herein;

FIG. 8 depicts a user interface for providing a manager with a listing of software that members of a group may have acquired, according to embodiments disclosed herein;

FIG. 9 depicts a user interface that may be provided for a particular piece of software, according to embodiments disclosed herein; and

FIG. 10 depicts a flowchart for providing a software license, according to embodiments disclosed herein.

### DETAILED DESCRIPTION OF THE INVENTION

Embodiments disclosed herein include systems and methods for providing a software license. Accordingly, these embodiments may be configured to provide an online (wide area and/or local area) marketplace for an employee or other user to purchase and/or rent software licenses. As an example, if the user wishes to purchase software, the user can navigate the user computing device to the online marketplace, which may include a plurality of different software packages. The user may search the online marketplace for the desired software package and can then acquire the desired software package for a predetermined fee. The predetermined fee may be based on a monthly charge, a weekly charge, a one-time charge for a predetermined usage timeframe, and/or other fee. Regardless, the user may then download the desired software onto the user computing device.

Additionally, the user computing device may include an “agent application” that monitors which software packages are loaded and installed onto the user computing device. Thus, the agent application can determine that the desired software package has been installed on the user computing device and monitor the user's use of the desired software package. As the user may be charged periodically for the desired software package, upon uninstalling the desired software package, the agent application can communicate with the online marketplace to indicate that the user no longer possesses the desired software package, thus effectively returning the license associated with that software. This communication may thus trigger a stop in billing of the user for the desired software package. Similarly, if the user paid for the desired software package for a predetermined usage timeframe, upon expiration of that timeframe, the agent application may disable and/or uninstall the desired software package from the user computing device.

Regardless of the mechanism for the user to uninstall the desired software package, once this occurs, the online marketplace may reacquire that software license. Thus, the online marketplace may reuse that license for another user to acquire the desired software package. This allows for a more efficient and cost effective mechanism for users to legally acquire software.

Additionally, the user may search the online marketplace for a software package to which no license has been acquired by the online marketplace or a software package to which a less expensive alternative is available. Specifically, if the user searches for a software package that is currently not available in the online marketplace, the online marketplace may facilitate a wide area search for the unavailable software package. Upon locating the unavailable software package, the online marketplace may purchase one or more licenses for the unavailable software package and facilitate an upload of the unavailable software package to the user computing device. Additionally, the unavailable software package may then be made available to other users, based on the terms of the newly acquired license.

In situations where a user searches for a costly software package, the online marketplace and/or the agent application can determine the actual functionality the user wishes performed by the costly software package. In some embodiments, this may simply be determined from the fact that the user is requesting the costly software package. However, in some embodiments, a determination of the user's actual expected use may be may be made such as through past actions, a questionnaire, contacting a manager, etc. Regardless, the online marketplace may then determine whether a less expensive alternative software package is available that will provide the desired functionality. If so, the online marketplace may provide an option for the user to acquire the alternative software package.

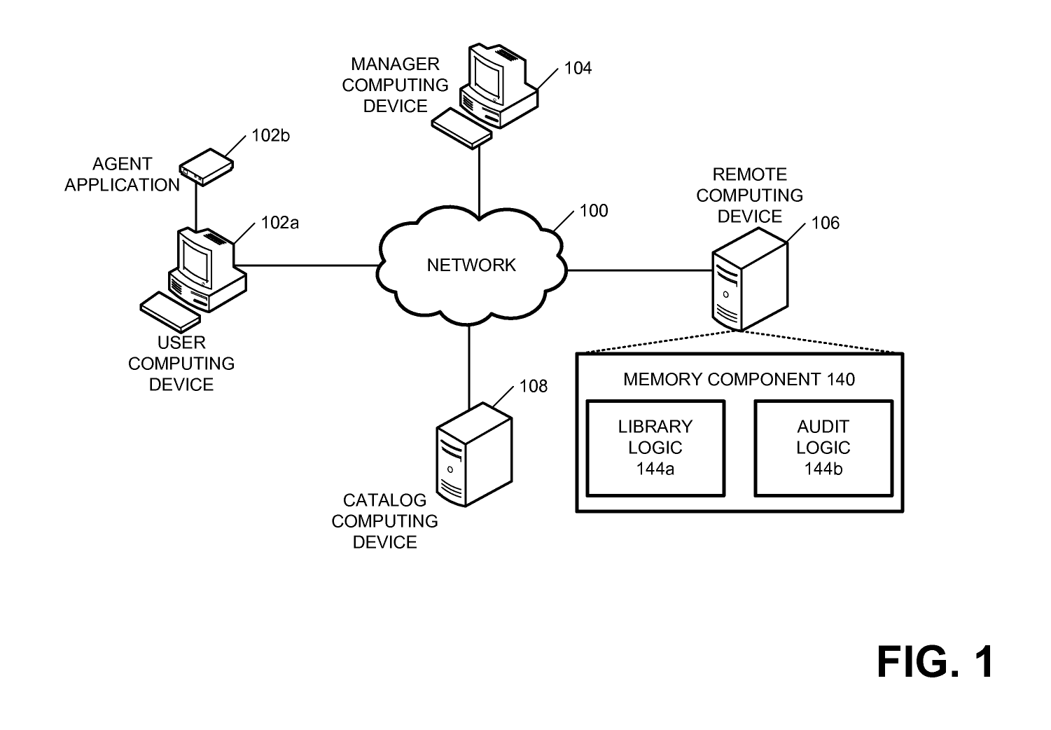

Referring now to the drawings, FIG. 1 depicts a computing environment for providing a software license, according to embodiments disclosed herein. As illustrated, a network 100 may be coupled to a user computing device 102a, agent application 102b, manager computing device 104, a remote computing device 106, and a catalog computing device 108. The network 100 may include any wide area and/or local area network, such as the internet, a mobile communications network, a satellite network, a public service telephone network (PSTN) and/or other network for facilitating communication between devices. If the network 100 includes a local area network, the local area network may be configured as a corporate network, school network, and/or other open or closed network that is coupled to a wide area network.

Accordingly, the user computing device 102a may include a personal computer, laptop computer, tablet, mobile computing device, mobile communications device, database, and/or other computing device operated by a corporate employee or other entity. As illustrated, the user computing device 102a may include and/or be coupled with an agent application 102b. While the agent application 102b is illustrated as a hardware device that is external to the user computing device 102a, this is merely an example. Specifically, in many embodiments the agent application 102b is merely a piece of software that is executed by the user computing device 102a. Regardless, the user computing device 102a may receive data from the remote computing device 106, as well as install software and monitor installed software, as described in more detail below.

Similarly, the manager computing device 104 may include hardware and/or software to interact with the remote computing device 106, the catalog computing device 108, and/or the user computing device 102a. The manager computing device 104 may be configured to oversee the one or more user computing devices 102a that are part of a common group to which the manager computing device 104 manages to determine software licenses, software use, etc.

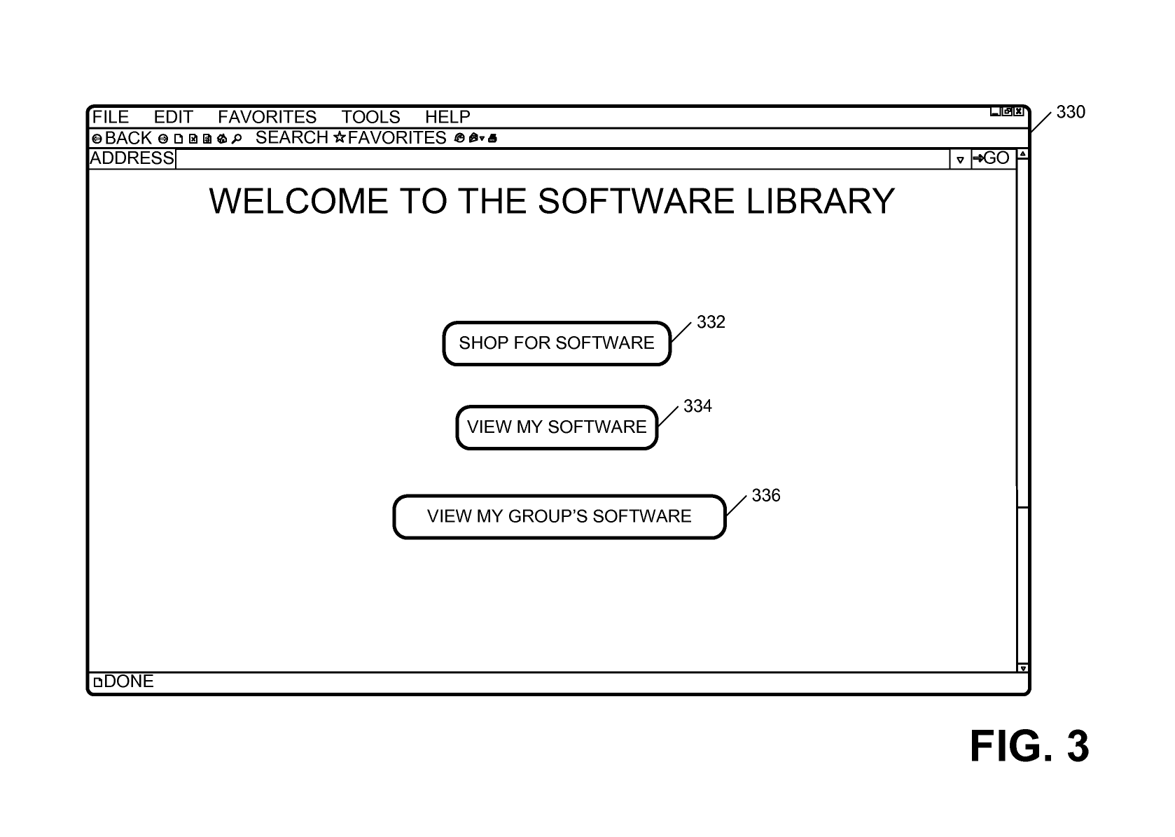

The remote computing device 106 may be configured to provide a marketplace for purchasing and/or renting licensed software to the user computing device 102a and/or the manager computing device 104. The remote computing device 106 may include a memory component 140, which includes library logic 144a and audit logic 144b. The library logic 144a may be configured to provide one or more of the interfaces depicted in FIGS. 3-9. Similarly, the audit logic 144b may be configured to communicate with the agent application 102b to determine which of the licensed software has not been used for a predetermined time, as well as facilitate removing of the software from the user computing device 102a and/or manager computing device 104, which effectively returns the license associated with that software. Similarly, the catalog computing device 108 may be configured to determine the validity of software licenses, the number of software licensees, etc. to ensure compliance with licenses provided by the remote computing device 106.

It should be understood that, similar to the manager computing device 104, the remote computing device 106, and the catalog computing device 108, the user computing device 102a may represent a plurality of different computing devices. Specifically, the manager computing device 104 may oversee a plurality of different user computing devices 102a. Similarly, some embodiments include a plurality of different manager computing devices 104 for overseeing different groups of users.

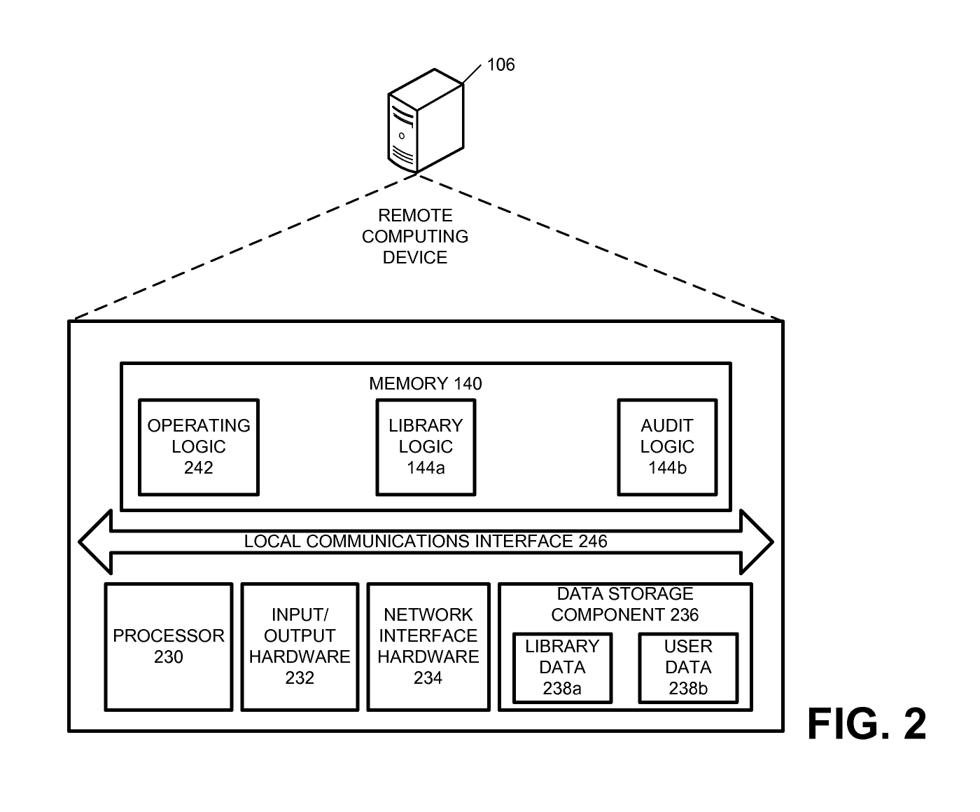

FIG. 2 depicts components of a remote computing device 106 for providing a software license, according to embodiments disclosed herein. In the illustrated embodiment, the remote computing device 106 includes a processor 230, input/output hardware 232, network interface hardware 234, a data storage component 236 (which stores library data 238a and user data 238b), and the memory component 140. The memory component 140 may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums.

Depending on the particular embodiment, these non-transitory computer-readable mediums may reside within the remote computing device 106 and/or external to the remote computing device 106.

Additionally, the memory component 140 may be configured to store operating logic 242, the library logic 144a, and the audit logic 144b, each of which may be embodied as a computer program, firmware, and/or hardware, as an example. A local communications interface 246 is also included in FIG. 2 and may be implemented as a bus or other interface to facilitate communication among the components of the remote computing device 106.

The processor 230 may include any processing component operable to receive and execute instructions (such as from the data storage component 236 and/or memory component 140). The input/output hardware 232 may include and/or be configured to interface with a monitor, keyboard, mouse, printer, camera, microphone, speaker, and/or other device for receiving, sending, and/or presenting data. The network interface hardware 234 may include and/or be configured for communicating with any wired or wireless networking hardware, a satellite, an antenna, a modem, LAN port, wireless fidelity (Wi-Fi) card, WiMax card, mobile communications hardware, and/or other hardware for communicating with other networks and/or devices. From this connection, communication may be facilitated between the remote computing device 106 and other computing devices.

Similarly, it should be understood that the data storage component 236 may reside local to and/or remote from the remote computing device 106 and may be configured to store one or more pieces of data for access by the remote computing device 106 and/or other components. In some embodiments, the data storage component 236 may be located remotely from the remote computing device 106 and thus accessible via the network 100. In some embodiments however, the data storage component 236 may merely be a peripheral device, but external to the remote computing device 106.

Included in the memory component 140 are the operating logic 242, the library logic 144a and the audit logic 144b. The operating logic 242 may include an operating system and/or other software for managing components of the remote computing device 106. Similarly, the library logic 144a may be configured to cause the remote computing device 106 to provide library data as a marketplace for users and/or managers to purchase and/or rent licensed software. Similarly, the audit logic 144b may be configured to cause the remote computing device 106 to communicate with the agent application 102b (via the user computing device 102a and the remote computing device 106) to determine software usage and software use charges, as well as facilitate returning of software licenses and removal of software from the user computing device 102a.

It should be understood that the components illustrated in FIG. 2 are merely exemplary and are not intended to limit the scope of this disclosure. While the components in FIG. 2 are illustrated as residing within the remote computing device 106, this is merely an example. In some embodiments, one or more of the components may reside external to the remote computing device 106. It should also be understood that, while the remote computing device 106 in FIGS. 1 and 2 is illustrated as a single system, this is also merely an example. In some embodiments, the content providing functionality is implemented separately from the advertisement functionality, which may be implemented with separate hardware, software, and/or firmware.

FIG. 3 depicts a user interface 330 for providing options related to licensed software that a user may utilize, according to embodiments disclosed herein. As illustrated, the user interface 330 may be provided to the user computing device 102a for viewing software and/or shopping for software. Specifically, a corporate employee or other user of the user computing device 102a may need a new piece of software. The user may purchase the new software through a source that is external to the online marketplace, but oftentimes, the software license for this external purchase may not cover the intended commercial use. Accordingly, the manager and/or corporation, as a whole, may prefer that the employees utilize the marketplace discussed herein.

Referring again to FIG. 3, the user interface 330 includes a “shop for software” option 332, a “view my software” option 334, and a “view my group's software” option 336. As discussed in more detail below, in response to selection of the shop for software option 332, the user (or manager) may be provided with a marketplace for shopping for one or more pieces of software. In response to selection of the view my software option 334, the user may be provided with a listing of software that is currently installed on the user computing device 102a. In response to selection of the view my group's software option 336, the manager may be provided with a listing of software that is installed on one or more of the user computing devices 102a.

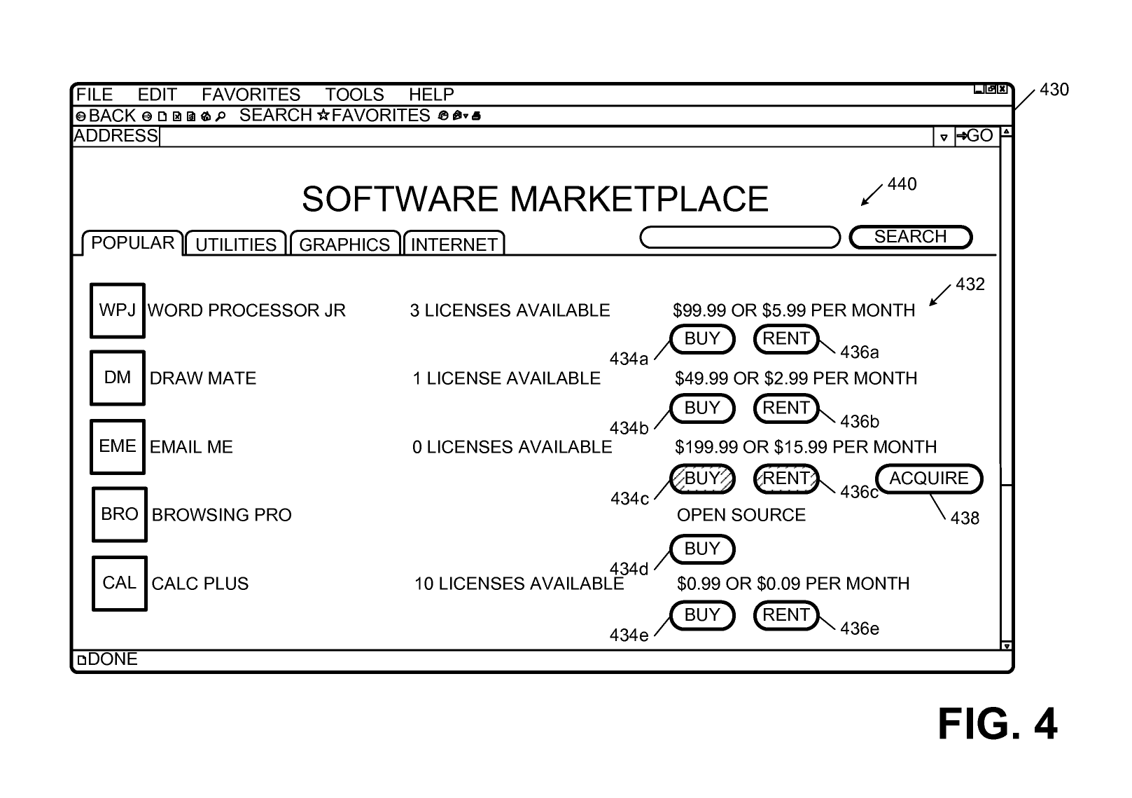

FIG. 4 depicts a user interface 430 for providing a marketplace to purchase and/or rent software, according to embodiments disclosed herein. In response to selection of the shop for software option 332 from FIG. 3, a software marketplace may be provided in the user interface 430. Specifically, the user interface 430 may be configured as a mechanism for users (which may include employees, students, and/or others) to purchase and/or rent software. In the corporate environment, this allows a corporation to reduce software license costs, as well as ensure compliance with the license requirements of the software being used on a company device. Accordingly, the user interface 430 includes a software section 432, which includes one or more pieces of licensed software that may be acquired by the user computing device 102a. As illustrated, the software section 432 lists the available software, the licenses available for that software, a purchase option, such as buy options 434a-434e (collectively referred to as “buy option 434”), and a rent option 436a-436e (collectively referred to as “rent option 436”) to purchase or rent software from the internal online marketplace.

As illustrated, the user may purchase the software via selection of the buy option 434. Similarly, if the user believes that he/she will only use the software for a short amount of time, the user may select the rent option 436 by which the user can acquire the software and simply pay a monthly (or other periodic) fee for the software. As described in more detail below, if the user, agent application 102b, and/or remote computing device 106 determine that the software has not been used for a predetermined amount of time, or if a determination is made that the user has completed the project that utilizes this software, the user may uninstall the software, thereby returning the license.

Additionally illustrated in FIG. 4, the “email me” software currently does not have any licenses available. As such, the buy option 434c and the rent option 436c may be disabled from selection. Additionally, an acquire option 438 may be provided, such that the user may acquire the software, despite the current lack of licenses. In response to selection of the acquire option 438, the remote computing device 106 can perform any of several different actions. In some embodiments, the remote computing device 106 can determine a user computing device 102a that has not used the software for the longest amount of time. The remote computing device 106 can then send a message to that user computing device 102a to determine if that user and/or manager will relinquish the license. In some embodiments, the remote computing device 106 may simply search and acquire one or more additional licenses for the new request. Additionally, if the user does not locate the desired licensed software in the user interface 530, the user may perform a keyword search in the search section 440.

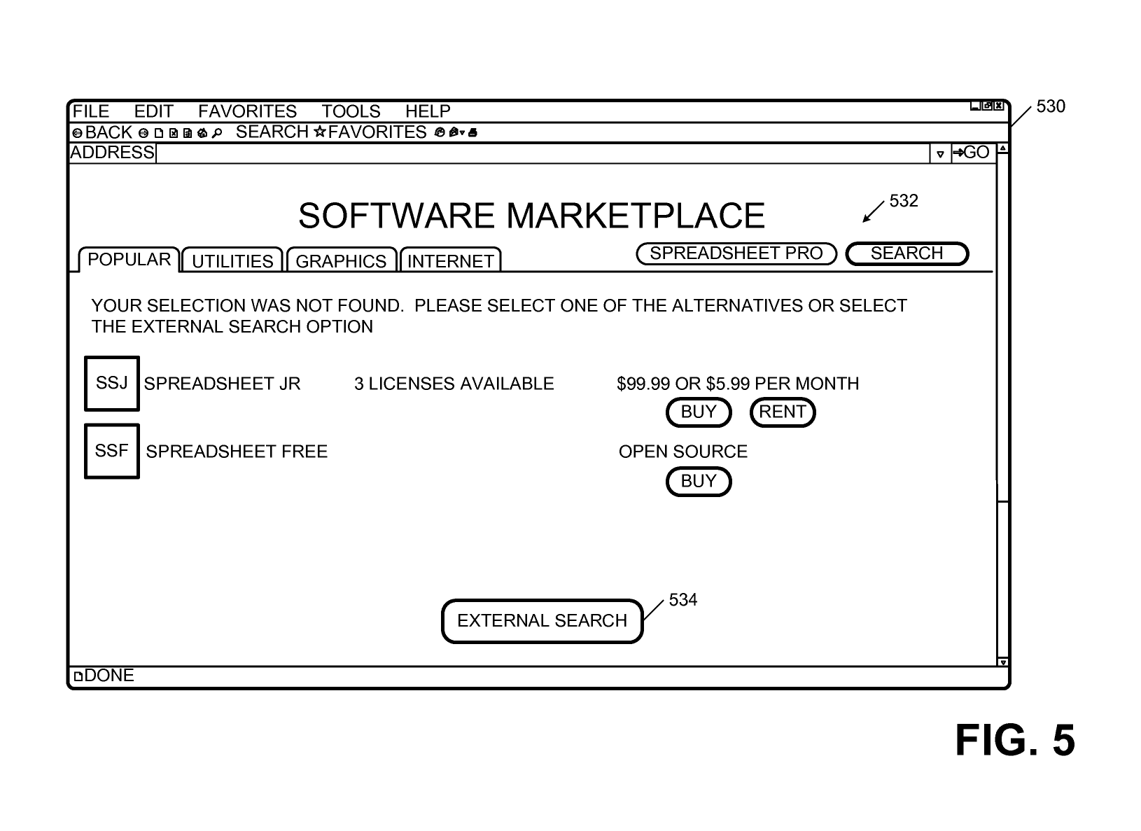

FIG. 5 depicts a user interface 530 for locating software from an external vendor site to the marketplace, according to embodiments disclosed herein. In response to performing the search from the search section 440 in FIG. 4, the user interface 530 may be presented. As illustrated, the user interface 530 provides a listing of one or more pieces of software associated with the received search term. In the illustrated example, the user searched for “spreadsheet pro” in the search area 532. After performing the search, the remote computing device 106 was unable to locate the desired licensed software. However, the remote computing device 106 was able to locate two pieces of software that are similar to the search terms. An external search option 534 is also provided to initiate a search of other external vendors who may provide the requested software.

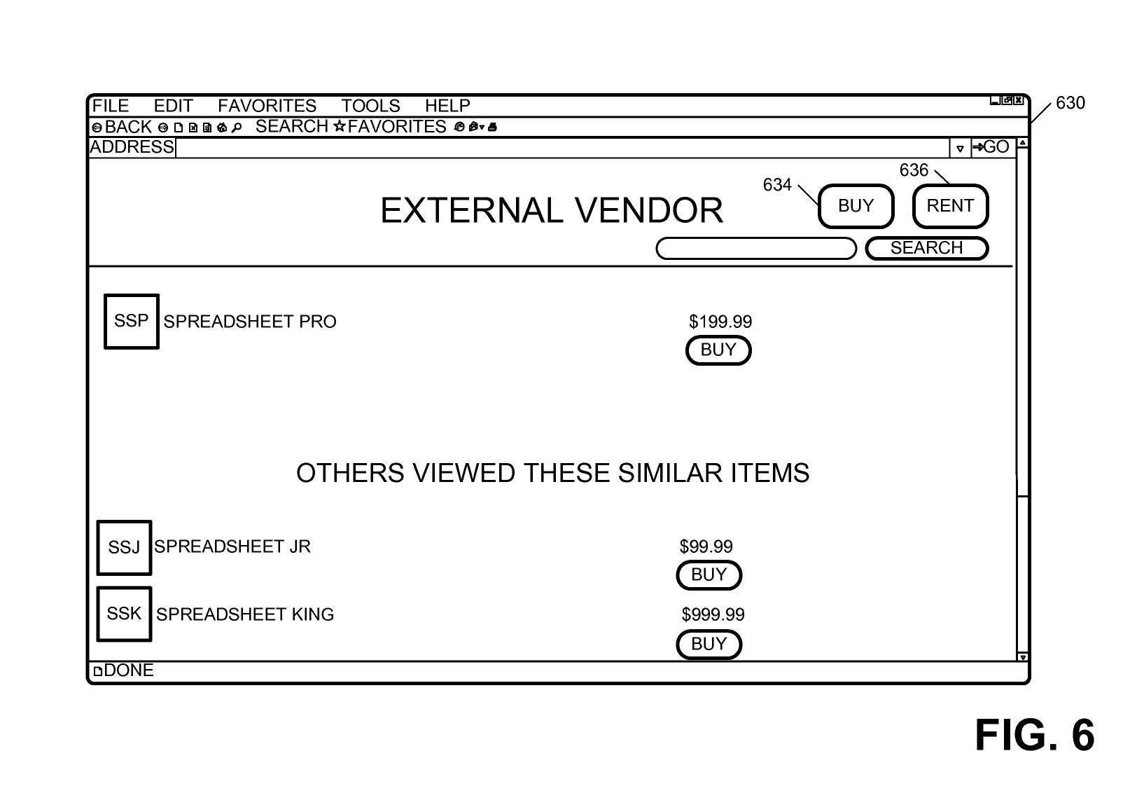

FIG. 6 depicts a user interface 630 for purchasing and/or renting software through an external vendor site, via the marketplace, according to embodiments disclosed herein. In response to selection of the external search option 534 from FIG. 5, the user interface 630 may be provided. The user interface 630 includes a webpage or other portal to the external vendor site, which includes the desired licensed software. Also included in the user interface 630 is a marketplace overlay section 632, which includes a buy option 634 and a rent option 636. Specifically, while the user may purchase the software from the external vendor site, the buy option 634 and the rent option 636 cause purchase or rental of the software via the marketplace. Accordingly, in response to one of the options 634, 636, the remote computing device 106 and/or the catalog computing device 108 may negotiate terms of acquiring one or more licenses of the software from the external vendor. This provides the user with the ability to ensure that a valid license is obtained that will cover his/her specific use of the software.

While the user interface 630 includes options to purchase the software directly from the external vendor, this is just an example. Specifically, in some embodiments, the external vendor site may be deactivated to prevent the user from purchasing the software directly from the external vendor. Similarly, some embodiments may be configured to simply scrape data from the external vendor site and provide the options 634 and 636 as the only options for acquiring the software.

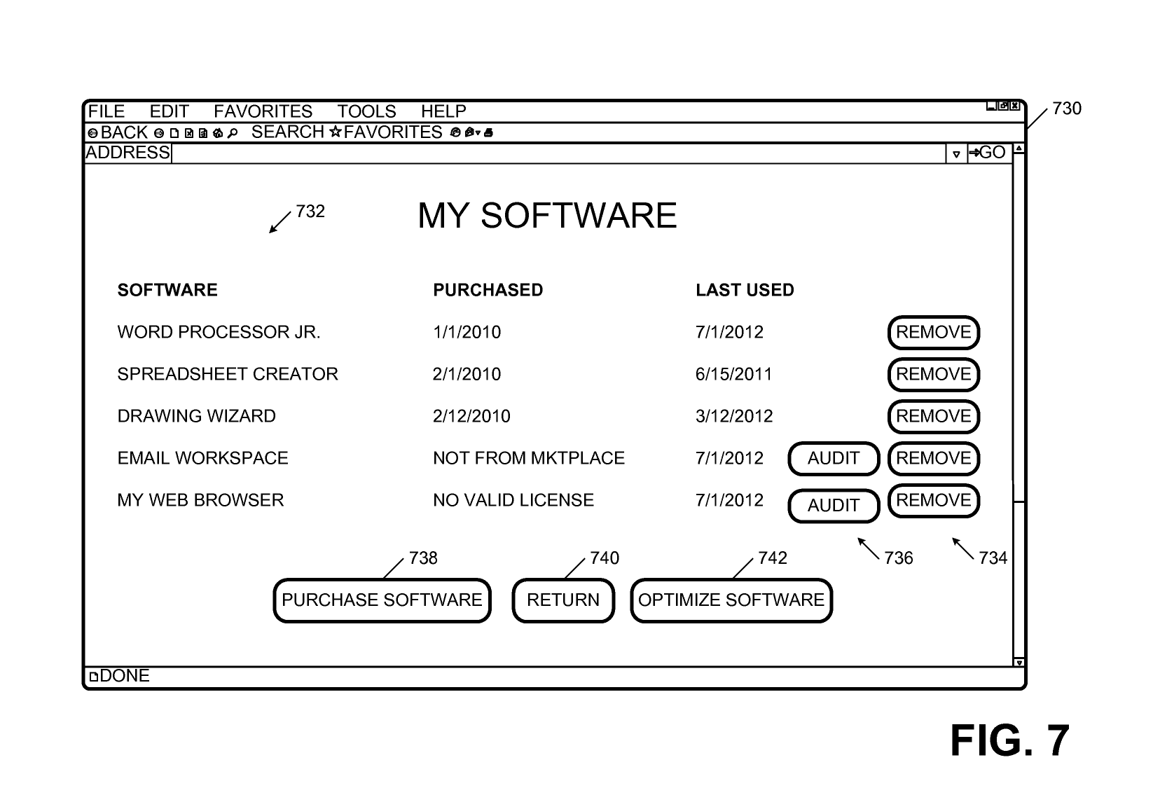

FIG. 7 depicts a user interface 730 for providing a listing of software that a user has acquired on a user computing device 102a, according to embodiments disclosed herein. In response to a user of the user computing device 102a selecting the view my software option 334 (FIG. 3), the user interface 730 may be provided. As illustrated, the user interface 730 includes a listing 732 of software that is currently installed on the user computing device 102a. The listing provided in the user interface 730 includes word processing software, spreadsheet software, drawing software, email software, and a web browsing software. Also included are remove options 734 for the user to remove a particular piece of software from the user computing device 102a. Specifically, the agent application 102b may be configured to monitor the software that is installed on the user computing device 102a. The remote computing device 106 can communicate with the agent application 102b via the user computing device 102a to determine the software on the user computing device 102a, as well as provide the options depicted in the user interface 730. Accordingly, when the user selects the remove option 734 related to one of the pieces of software, the remote computing device 106 can send the request to the agent application 102b (or the agent application 102b may receive the request directly). Regardless, the agent application 102b can then facilitate removal of the software from the user computing device 102a, effectively returning the software license to the remote computing device 106.

Additionally, the agent application 102b and/or the remote computing device 106 may determine which of the software includes a valid software license. As illustrated, the user installed the word processor software, the spreadsheet software, and the drawing software via the marketplace. Accordingly, the agent application 102b and/or the remote computing device 106 have a record of the date the software was purchased and can verify that the software license is valid. The email software, however, was not purchased from the marketplace. Accordingly, the agent application 102b and/or the remote computing device 106 may be unable to verify if the software was purchased with a valid software license. Similarly, the web browser application has been identified as not being acquired with a valid license. As such, the agent application 102b may be configured to automatically remove the web browser application. In some embodiments, upon a determination that a valid license is not present, a notification may be sent to the user, manager, and/or other entity.

Because the email software and the web browser may not be associated with a valid license, the user interface 730 may additionally include audit options 736. As discussed in more detail below, in response to selection of the audit option 736, the agent application 102b and/or the remote computing device 106 may determine the nature and status of the software license issue. Also included in the user interface 730 is a purchase software option 738, a return option 740, and an optimize software option 742. In response to selection of the purchase software option 738, the user may be provided with one or more marketplace user interfaces, as depicted in FIGS. 4-6. In response to selection of the return option 740, the user may be directed to a previous user interface (such as the user interface 330 depicted in FIG. 3). In response to selection of the optimize software option 742, the agent application 102b and/or the remote computing device 106 may perform a full audit and remove software that is not associated with a valid software license and/or software that has not been used for a predetermined amount of time.

In some embodiments, a determination may also be made regarding the date of last use of the software. If a determination is made that the software has not been used for a predetermined amount of time (e.g., one week, one month, one year, etc.), the agent application 102b and/or remote computing device 106 may facilitate removal of the software from the user computing device 102a, as well as return of the license to the remote computing device 106. It should be understood that returning of the licenses may simply be an indication provided to the remote computing device 106 that the software has been uninstalled.

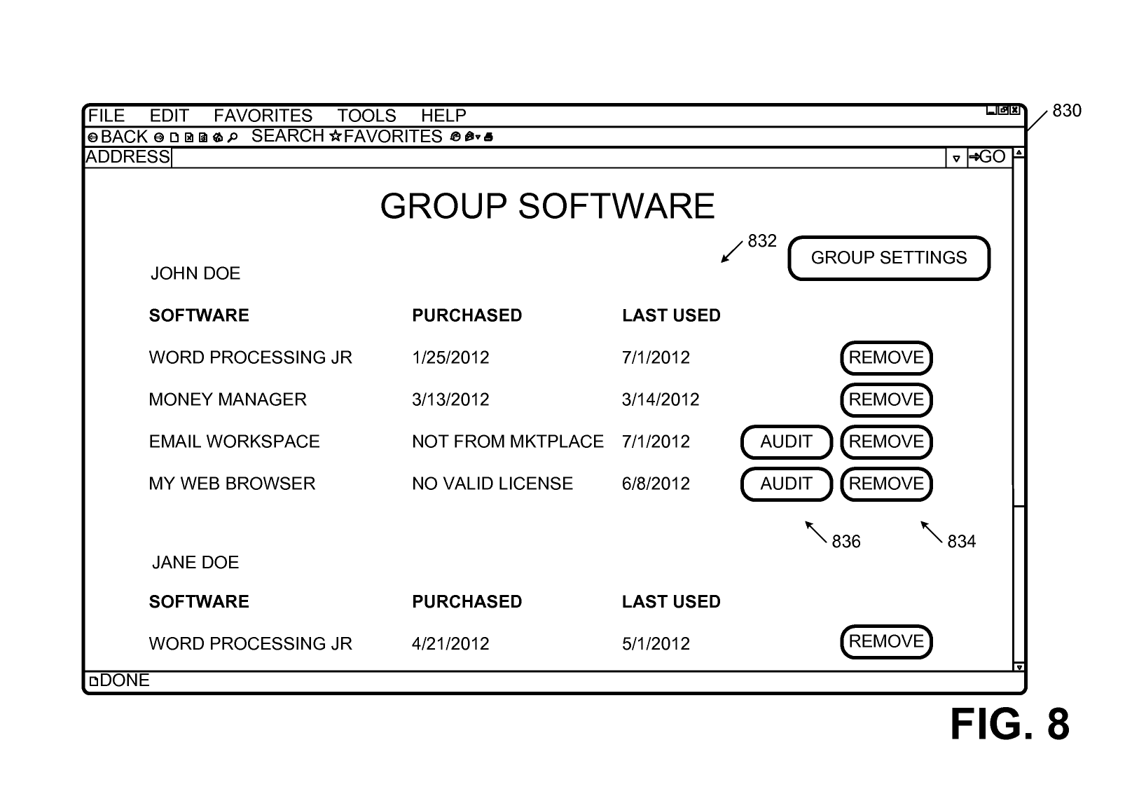

FIG. 8 depicts a user interface 830 for providing a manager with software that members of a group may have acquired, according to embodiments disclosed herein. In response to selection of the view my group's software option 336 from FIG. 3, the user interface 830 may be provided. Specifically, the user interface 830 includes a group software section 832, which provides software installed on one or more user computing devices 102a that are monitored by the manager computing device 104. As illustrated, the manager may be provided with access to audit and/or remove software from a user computing device 102a, through the use of a manager option, such as remove options 834 and audit options 836. Also included is a group settings option 838, which may be utilized to dictate the level of access to software that a user or manager may be given.

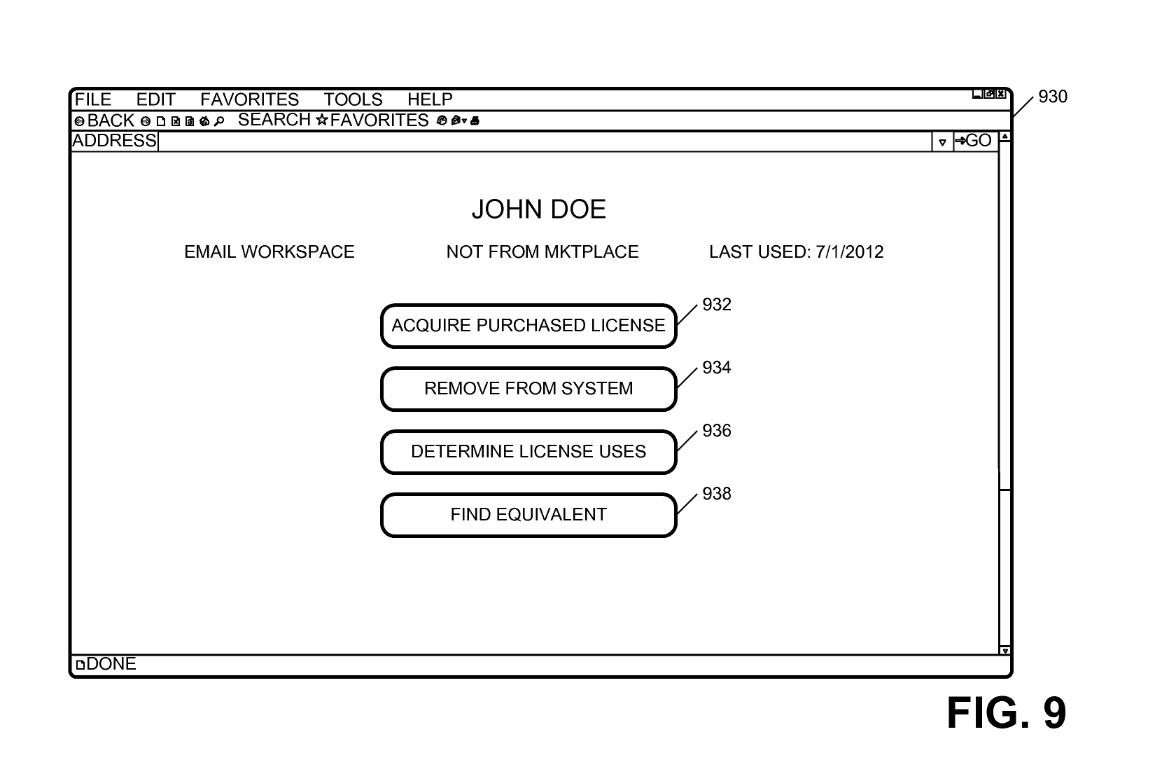

FIG. 9 depicts a user interface 930 that may be provided for a particular piece of software, according to embodiments disclosed herein. In response to selection of the audit option 736 from FIG. 7 or the audit option 836 from FIG. 8 for the email workspace software, the user interface 930 may be provided. Specifically, the user interface 930 includes an acquire purchased license option 932, a remove from system option 934, a determine license uses option 936, and a find equivalent option 938.

In response to selection of the acquire purchased license option 932, the remote computing device 106 and/or the catalog computing device 108 may acquire a license for the software, such as via the mechanism described with regard to the acquire option 438 in FIG. 4 and/or via the mechanism described with regard to acquiring software from an external vendor site from FIG. 6. Similarly, in response to selection of the remove from system option 934, the email workspace software may be removed from the user computing device 102a, thereby returning the acquired license. In response to selection of the determine license uses option 936, the user and/or manager may be provided with acceptable uses for the licenses, to ensure that the current use meets the license restrictions. In response to selection of the find equivalent option 938, the remote computing device 106 and/or catalog computing device 108 may locate equivalent software to which a license may be available. As an example, if the user installed a proprietary piece of software without a valid license, in response to selection of the find equivalent option 938, a freeware or open source version of the software may be provided in its place.

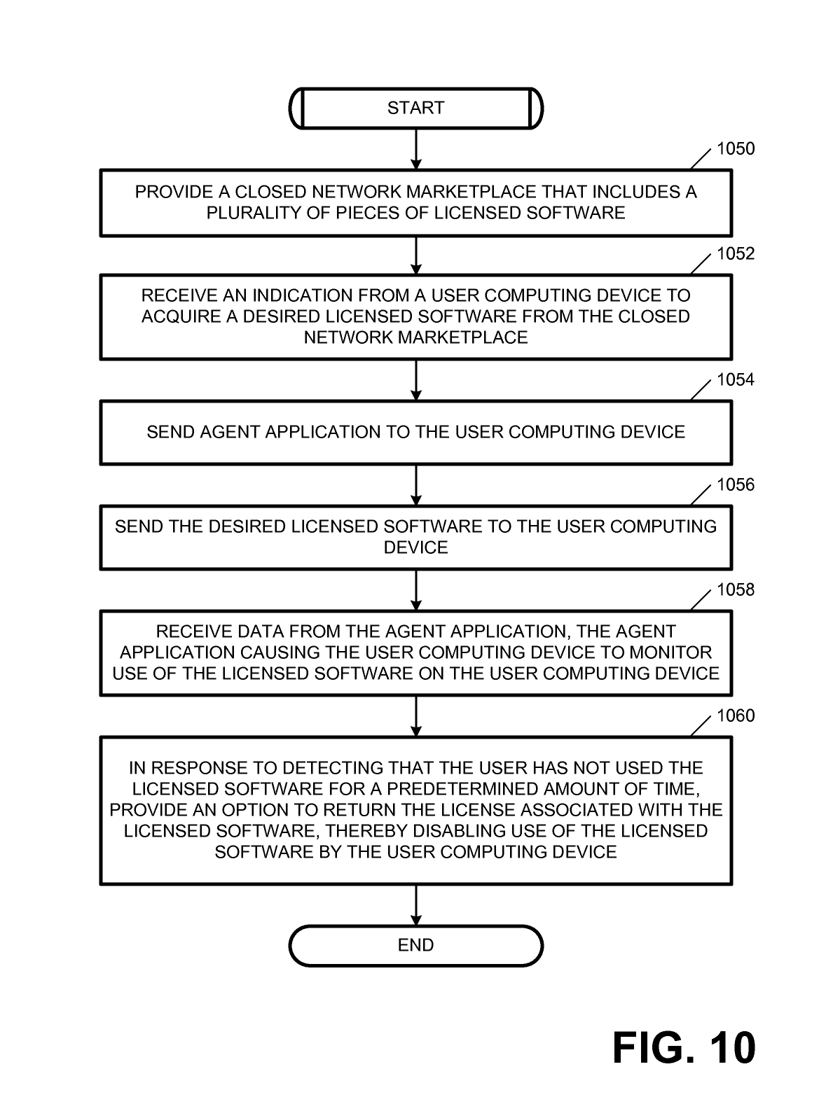

FIG. 10 depicts a flowchart for providing a software license, according to embodiments disclosed herein. As illustrated in block 1050, a closed network marketplace may be provided that includes a plurality of pieces of licensed software. As discussed above, providing the marketplace may include determining software that will be provided and then providing links to purchase and/or rent that software. In block 1052, an indication from a user may be received at a user computing device 102a to acquire a desired licensed software from the closed network marketplace. In block 1054, the agent application 102b may be sent to the user computing device 102a. In block 1056, the desired licensed software may be sent to the user computing device 102a. In block 1058, data may be received from the agent application 102b (via the user computing device 102a). The agent application 102b may cause the user computing device 102a to monitor use of the licensed software on the user computing device 102a. In block 1060, in response to detecting that the user has not used the licensed software for a predetermined amount of time, an option to return the license associated with the licensed may be provided, thereby disabling use of the licensed software by the user computing device 102a. In some embodiments this includes generating a user interface and including a user option in the user interface.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be understood to those skilled in the art that various other changes and modifications can be made without departing from the spirit and scope of the invention. It is therefore intended to cover in the appended claims all such changes and modifications that are within the scope of this invention.

What is claimed is:

1. A method for providing a software license, comprising:
providing a closed network marketplace that includes a plurality of pieces of licensed software;
receiving an indication from a user computing device to acquire a desired licensed software from the closed network marketplace;
sending the desired licensed software to the user computing device;
receiving data from an agent application, the agent application causing the user computing device to monitor use of the desired licensed software on the user computing device; and
in response to receiving the data from the agent application, providing, by a computing device, providing a user option to remove the desired licensed software from the user computing device, thereby effectively returning the software license associated with the desired licensed software such that the software license may be used on another computing device.

2. The method of claim 1, further comprising providing the agent application to the user computing device.

3. The method of claim 1, wherein request to acquire the desired licensed software comprises:
determining whether the closed network marketplace provides the desired licensed software; and
in response to determining that the closed network marketplace does not provide the desired licensed software, navigating the user computing device to an external vendor site to acquire the desired licensed software.

4. The method of claim 3, wherein acquiring the desired licensed software comprises acquiring the software license from the external vendor site at the closed network marketplace.

5. The method of claim 3, further comprising providing a purchase option to purchase the desired licensed software from the external vendor site, through the closed network marketplace.

6. The method of claim 3, further comprising providing a rent option to rent the desired licensed software from the external vendor site, through the closed network marketplace.

7. The method of claim 1, further comprising providing a manager computing device with access to the user computing device and another computing device, wherein the access includes a manager option to return the desired licensed software to the closed network marketplace.

8. A system for providing a software license comprising:
a memory component that stores logic, that when executed by the system, causes the system to perform at least the following:
provide a marketplace for members of a corporate entity to acquire a desired licensed software, the marketplace providing a plurality of pieces of licensed software;
receive an indication from a user computing device to acquire the desired licensed software from the marketplace, wherein the user computing device stores an agent application for monitoring use of the user computing device;
send the desired licensed software to the user computing device;
receive data from the agent application, the data indicating that the desired licensed software has not been used on the user computing device for predetermined amount of time; and
receive an indication from the user computing device to remove the desired licensed software from the user computing, effectively returning the software license associated with the desired licensed software, the indication being received in response to a selection of a user option.

9. The system of claim 8, wherein the logic further causes the system to provide the user option to the user computing device to remove the desired licensed software for the user computing device.

10. The system of claim 8, wherein request to acquire the desired licensed software comprises:
determining whether the marketplace provides the desired licensed software; and
in response to determining that the marketplace does not provide the desired licensed software, navigating the user computing device to an external vendor site to acquire the desired licensed software.

11. The system of claim 10, wherein acquiring the desired licensed software comprises acquiring the software license from the external vendor site at the marketplace.

12. The system of claim 10, wherein the logic further causes the system to provide a purchase option to purchase the desired licensed software from the external vendor site, through the marketplace.

13. The system of claim 10, wherein the logic further causes the system to provide a rent option to rent the desired licensed software from the external vendor site, through the marketplace.

14. The system of claim 8, wherein the logic further causes the system to provide a manager computing device with access to the user computing device and another computing device, wherein the access includes an option to return the desired licensed software to the marketplace.

15. A non-transitory computer-readable medium that stores a computer program for providing a software license that, when executed by a computing device, causes the computing device to perform at least the following:
provide a marketplace for members of a corporate entity to acquire a desired licensed software;
receive an indication from a user computing device of the corporate entity to acquire the desired licensed software from the marketplace, wherein the user computing device stores an agent application for monitoring use of the user computing device;
send the desired licensed software to the user computing device;
receive data from the agent application, the data indicating that the desired licensed software has not been used on the user computing device for predetermined amount of time; and
receive an indication from the user computing device to disable use of the desired licensed software by the user computing device, thereby effectively returning the software license associated with the desired licensed software for use with another computing device, the indication being received in response to a selection of a user option.

16. The non-transitory computer-readable medium of claim 15, wherein the computer program causes the computing device to provide, in response to receiving the data from the agent application, an option to return the software license.

17. The non-transitory computer-readable medium of claim 15, wherein request to acquire the desired licensed software comprises:
determining whether the marketplace provides the desired licensed software; and
in response to determining that the marketplace does not provide the desired licensed software, navigating the user computing device to an external vendor site to acquire the desired licensed software,
wherein acquiring the desired licensed software comprises acquiring the software license from the external vendor site at the marketplace.

18. The non-transitory computer-readable medium of claim 17, wherein the computer program further causes the computing device to provide a purchase option to purchase the desired licensed software from the external vendor site, through the marketplace.

19. The non-transitory computer-readable medium of claim 17, wherein the computer program further causes the computing device to provide a rent option to rent the desired licensed software from the external vendor site, through the marketplace.

20. The non-transitory computer-readable medium of claim 15, wherein the computer program further causes the computing device to provide a manager computing device with access to the user computing device and another computing device, wherein the access includes an option to return the desired licensed software to the marketplace.
